(19) United States
(12) Patent Application Publication
(10) Pub. No.: US 2024/0296540 A1
(43) Pub. Date: Sep. 5, 2024

(54) Defect Detection Prediction with a Compact Set of Prediction Channels

(71) Applicant: AI QUALISENSE 2021 LTD, Tel Aviv-Yafo (IL)

(72) Inventor: Shimon Cohen, Ness Ziona (IL)

(73) Assignee: AI QUALISENSE 2021 LTD, Tel Aviv-Yafo (IL)

(21) Appl. No.: 18/593,942

(22) Filed: Mar. 3, 2024

Related U.S. Application Data
(60) Provisional application No. 63/488,149, filed on Mar. 2, 2023.

(51) Int. Cl. G06T 7/00

(52) U.S. Cl. CPC G06T 7/0004; G06T 2207/20084

(57) ABSTRACT

A computerized method for defect detection prediction with a compact set of prediction channels, the method may include (i) obtaining a manufactured item (MI) image; (ii) generating, by a machine learning process, pixel predictions per multiple pixels of one or more feature maps related to the MI image; wherein the pixel predictions consist essentially of a probability (P) of defect, bounding height (H) and bounding box width (W); wherein the machine learning process was trained to (i) detect defects bounded by bounding boxes that have selected aspect ratios, and (ii) ignore defects bounded by bounding boxes that have non-selected aspect ratios; (iii) selecting, out of the multiple pixels, pixels based on values of at least one of the pixel predictors to provide a plurality of selected pixels; (iv) determining, based on the selected pixels, suspected defect bounding boxes; and (v) responding to the determining.

### BACKGROUND

Various defect detection neural network architectures—such as YOLO2, YOLO3, YOLO4, RETINANET, and FASTER RCNN have predictors that operate on a cell to cell basis (each cell includes multiple pixels), and their predictors calculate five cell properties—probability (P) of defect, bounding height (H), bounding box width (W), x-axis of defect within cell (X0) and y-axis of defect within cell (Y0). Each cell property requires a dedicated channel—which is associated with additional memory and computational resources. Training a neural network with cell-basis information also reduces the accuracy of the training—as there are less cells than pixels—and fewer effective training information. There is a growing need to provide an efficient defect detection network.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of an image and a feature pyramid network (FPN); and

FIG. 4 illustrates an example of a system.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the perception unit, narrow AI agents, MI evaluation unit may be implemented in hardware and/or code, instructions and/or commands stored in a non-transitory computer readable medium, may be included in a vehicle, outside a vehicle, in a mobile device, in a server, and the like.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provided a method that may process a large number of images each image may include thousands (and even more) pixels, to provide real time indication about the state (for example defects of evaluated IM) of evaluated MIs. Real time many mean tens of images per second and even more. This real time processing may be crucial in MIs evaluation—and allows to send real time feedback to a manufacturing process, and for other purposes. The suggested solution is both accurate and also resource consuming and provides an advance in computer science.

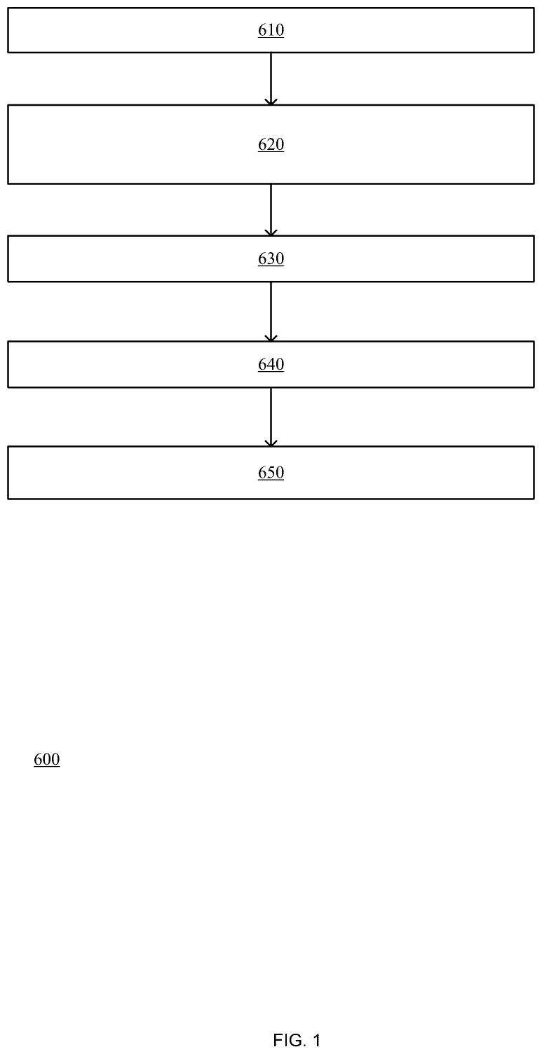

FIG. 1 illustrates an example of a method 600 for defect detection prediction with a compact set of prediction channels.

The term compact may mean that the set of prediction channels includes less prediction channels than YOLO3, YOLO4, YOLO5, RETINANET, and/or may mean that the set of prediction channels does not include location of object within cell prediction channels.

Method 600 may start by step 610 of obtaining a manufactured item (MI) image. The obtaining may include receiving, retrieving, fetching, generating (for example acquiring the MI image), processing a received IM image, and the like.

Step 610 may be followed by step 620 of generating, by a machine learning process, pixel predictions per multiple pixels of one or more feature maps related to the MI image. The multiple pixels of a feature map may include all pixels of the feature map, or may be only some of the pixels.

The pixel predictions consist essentially of a probability (P) of defect, bounding height (H) and bounding box width (W).

The machine learning process was trained to (i) detect defects bounded by bounding boxes that have selected aspect ratios, and (ii) ignore defects bounded by bounding boxes that have non-selected aspect ratios.

The selected aspect ratios may be determined in any manner. For example—the selected aspect ratios may be learnt during a supervised training process. The selected aspect ratios may be learnt during a supervised training process—by clustering aspect ratios of tagged defects in a training dataset. The selected aspect ratios may belong to the largest clusters. The largest clusters include the larger number of members. They may be the N2 largest clusters, wherein N2 may be predefined. They may be the clusters that have at least a predefined number of members, and the like.

Step 620 may be followed by step 630 of selecting, out of the multiple pixels, pixels based on values of at least one of the pixel predictors to provide a plurality of selected pixels. The selection may provide the most relevant pixels.

Step 630 may include selecting pixels that exhibit (a) a probability of defect above a probability threshold, and (b) a bounding box area above an area threshold. The bounding box area equals a width of a bounding box multiplied by a length of the bounding box. The probability threshold may be determined in any manner—for example to fulfill at least of the following conditions—have a certain (or a certain range of) false positive and/or have a certain (or a certain range of) a false negative, and/or have a certain (or a certain range of) a true positive and/or have a certain (or a certain range of) of false positive.

The area threshold may be determined in any manner. For example—a machine learning process may be trained to detect objects within a certain size range—wherein the certain size range may determined in any manner—for example in order to limit a size (and/or complexity and/or power consumption) of the machine learning process.

Step 630 may be followed by step 640 of determining, based on the selected pixels, suspected defect bounding boxes.

Step 640 may include setting centers of the suspected defect bounding boxes at centers of the selected pixels.

Step 640 may include applying a non-maximum suppression process on bounding boxes associated with the selected pixels.

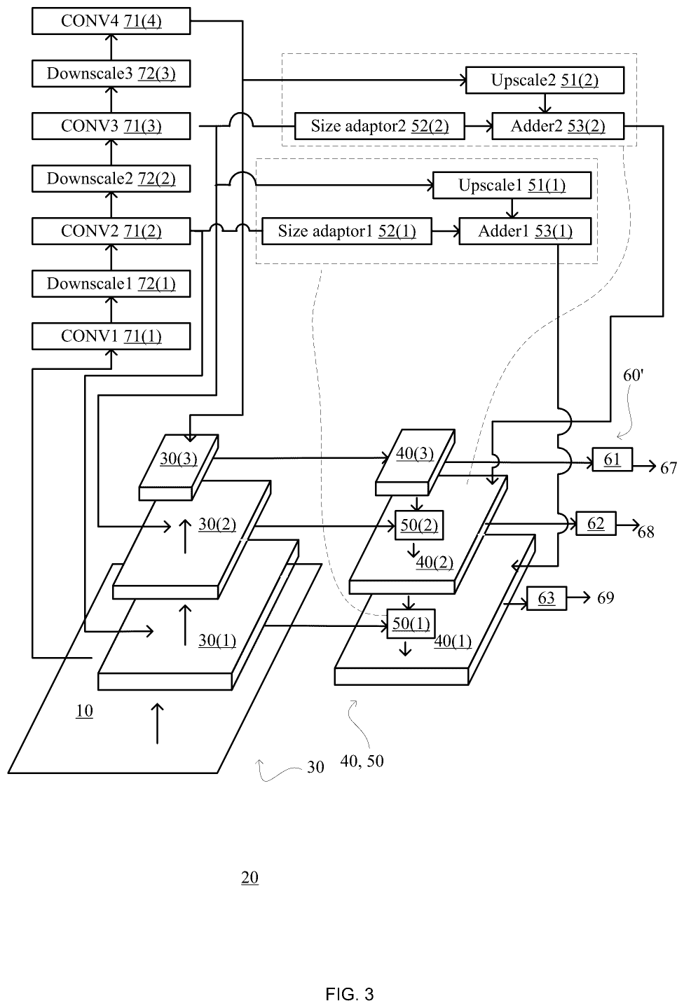

The applying a non-maximum suppression process may include:
a. Obtaining multiple candidates defect bounding boxes from one or more predictor of the machine learning process (see, for example, predictors 61, 62 and 63 of FPN 20 of FIG. 3).
b. Ordering the multiple candidates according to their P values to provide an ordered list of candidates.
c. Performing multiple iterations of
   i. Selecting a highest probability candidate of the current ordered list.
   ii. Defining the highest probability candidate as a defect indication.
   iii. Removing from the current ordered list the highest probability candidate and any other candidate of the current ordered list that is similar (have a similarity above a normalized cross correlation threshold) to the highest probability candidate.
   iv. Jumping to (i)—until the ordered list is empty—or until reaching any other stop condition.

The applying of step 640 calculates normalized cross correlation instead of calculating Intersection Over Union.

Step 640 may be followed by step 650 of responding to the determining. The responding may include outputting and/or storing defect detection information such as but not limited to suspected defect bounding boxes, suspected defects defect probability (P), generating a defect alert, changing (or asking a change in) a manufacturing process of the IMs, performing the manufacturing process, performing one or more manufacturing steps of the manufacturing process, and the like.

It should be noted that there may be provided a method that include determining a number of candidate bounding boxes generated by a predictor—and if the number exceeds a certain threshold—applying a method that is illustrated in US provisional patent concurrently filed with the current provisional—and has reference number COR-424—which is incorporated herein by reference. If the number is smaller than the certain threshold —executing method 600. The certain threshold may be determined in any manner—for example may be determined based on the available computational and/or memory resources.

The one or more feature maps are multiple feature maps associated with different spatial resolutions. They may be generated by a network that generated different spatial resolution versions of an image and/or of a feature map.

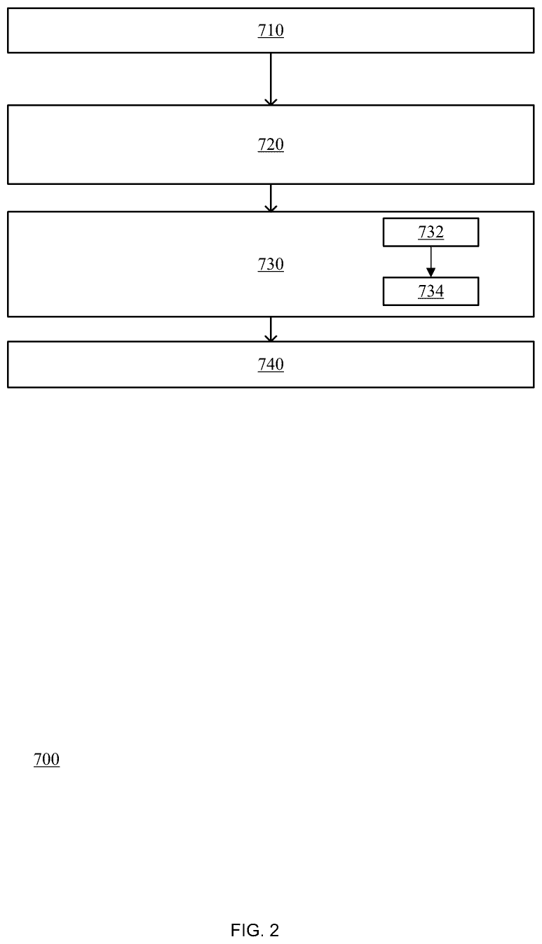

FIG. 2 illustrates an example of a method 700 for selecting aspect ratios.

Method 700 may start by step 710 of feeding tagged images to a first machine learning process. The tagged images are images of MI that are tagged with the locations of defects and the sizes of bounding boxes the bound the defects.

Step 710 may be followed by step 720 of processing the tagged images by the first machine learning process to provide pixel predictions that may include (or may consist essentially of) a probability (P) of defect, bounding height (H) and bounding box width (W).

Step 720 may also include calculating the aspect ratios (H/W) of the bounding boxes.

Step 720 may be followed by step 730 of selecting selected aspect ratios.

Step 730 may include steps 732 and 734.

Step 732 may include clustering the aspect ratios found in step 720 to provide aspect ratio clusters.

Step 732 may be followed by step 734 of selecting one or more selected aspect ratio clusters—for example selecting the N3 largest aspect ratio clusters (N3 may be determined in any manner), yet for another example—selecting aspect ratio clusters with at least a certain number of members, and the like.

The aspect ratios of the selected aspect ratio clusters form the selected aspect ratios. An aspect ratio of an aspect ratio cluster may be the centroid of the aspect ratio cluster, an integer that is closest to the centroid, and the like.

Step 730 may be followed by step 740 of training a second machine learning process to detect defects that are bounded by bounding boxes that have the selected aspect ratio and ignore elements (for example defects) of other aspect ratio.

Assuming that there are selected aspect ratios (for example 2:1, 1:1 and 1:2), then defects in the tagged images may have their bounding boxes linked to the selected aspect ratios. The linking may include calculating a normalized cross correlation between the selected aspect ratios and the actual bounding box aspect ratio of a defect. If, for a certain selected aspect ratio, the normalized cross correlation is above a normalized cross correlation threshold then the defect is mapped to that certain selected aspect ratio. If there are more than two selected aspect ratios have their normalized cross correlation above the normalized cross correlation threshold (for example 0.99, 0.9. 0.85, 0.8, 0.75 and 0.7) then the best matching selected aspect ratio is selected.

If there is no actual defect that has its bounding box match (normalized cross correlation above threshold) a certain selected aspect ratio—then the most similar actual bounding box aspect ratio (closest) is linked to that selected aspect ratio. For example—if the selected aspect ratios are 1:1, 2:1 and 1:2—and the actual bounding box aspect ratios of defects range between 1:2 and 1:2 and then range between 5:1 to 7:1—then the actual bounding box aspect ratio of 5:1 will be linked to the selected aspect ratio 2:1.

The second machine learning process may be the first machine learning process or may differ from the first machine learning process. The second machine learning process may be the machine learning process that executes method 600.

The machine learning process that executes method 700 (and maybe method 600) by various neural networks—for example by an FPN of FIG. 3.

FIG. 3 illustrates an example of an image 10 and an FPN 20.

The FPN 20 includes a backbone network 30, a feature pyramid 40, predictors 61-63, merged probability map generator 81, binarization unit 82, bounding box generator 83, and bounding boxes probability calculator 84.

For simplicity of explanation—FIGS. 1 illustrates a backbone network 30 that outputs (to the feature pyramid 40) three feature maps related to the EMI image (first feature map 30(1), second feature map 30(2) and third feature map 30(3)) of three different spatial resolutions (and of three contextual strengths). It should be noted that the FPN may output two feature maps or more than three feature maps .

The backbone network 30 may include a sequence that include first convolution layer (CONV171(1)), first downscaling unit (downscale1 72(1)), second convolution layer (CONV2 71(2)), second downscaling unit (downscale272(2)), third convolution layer (CONV3 71(3)), third downscaling unit (downscale3 72(3)), and fourth convolution layer (CONV4 71(4)).

The downscaling may by a factor of two—but other downscaling factors may be provided.

The fourth convolution layer outputs the third feature map 30(3) (that may equal a third feature map (40(3)) of the feature pyramid). The third convolution layer outputs the second feature map 30(2). The second convolution layer outputs the first feature map 30(1).

The feature pyramid include a first merging and size adaptation unit 50(1) and a second merging and size adaptation unit 50(2). The feature pyramid (FP) obtains first FP feature map 40(3) and calculates second FP feature map 40(2) and first FP feature map 40(1).

Each merging and size adaptation unit performs size adaptation (for example upsampling and channel length alignment) and add a size adjusted FP feature map to a lower level size adjusted feature map of the backbone network.

The second merging and size adaptation unit 50(2) includes a second upscaling unit (Upscale2 51(2)) that outputs an upscaled version of third FP feature map 40(3), a second size adaptor (Size adaptor252(2)—for example a 1×1 correlation unit) that outputs a channel size adapted second feature vector 30(2), and a second adder (Adder2 53(2)) that adds the outputs of the second size adaptor and the second upscaling unit to provide a second merging and size adaptation output that is the second FP feature map 40(2) of the feature pyramid.

The first merging and size adaptation unit 50(1) includes a first upscaling unit (Upscale1 51(1)) that outputs an upscaled version of second FP feature map 40(2), a first size adaptor (Size adaptor1 52(1)—for example a 1×1 correlation unit) that outputs a channel size adapted first feature vector 30(1), and a first adder (Adder1 53(1)) that adds the outputs of the first size adaptor and the first upscaling unit to provide a first merging and size adaptation output that is the first FP feature map 40(1).

The first FP feature map 40(1) is fed to a first predictor 61 (that may have an FP class subnet and may include a bounding-box subnet) that outputs a first FPN result—that is a first probability map 67.

The second FP feature map 40(2) is fed to a second predictor 62 that outputs a second FPN result—that is a second probability map 68.

The third FP feature map 40(3) is fed to a third predictor 63 that outputs a third FPN result—that is a third probability map 69.

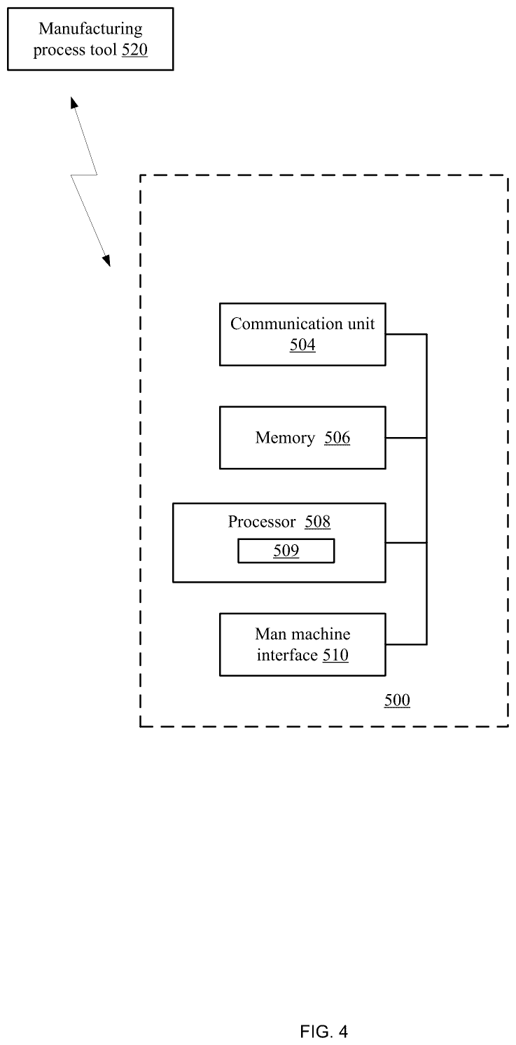

FIG. 4 is an example of a computerized system 500 and a manufacturing process tool 520.

The computerized system 500 may execute method 100.

The computerized system 500 may or may not communicate with the manufacturing process tool 520. It may, for example, provide feedback (for example the process variation alert) about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include communication unit 504, memory 506, processor 508 and may optionally include a man machine interface 510.

Processor 508 may execute the steps of method 600 and/or method 700. Memory 506 is configured to store any data element illustrated in any of the previous figures.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for defect detection prediction with a compact set of prediction channels, the method comprises:
obtaining a manufactured item (MI) image;
generating, by a machine learning process, pixel predictions per multiple pixels of one or more feature maps related to the MI image; wherein the pixel predictions consist essentially of a probability (P) of defect, bounding height (H) and bounding box width (W); wherein the machine learning process was trained to (i) detect defects bounded by bounding boxes that have selected aspect ratios, and (ii) ignore defects bounded by bounding boxes that have non-selected aspect ratios;
selecting, out of the multiple pixels, pixels based on values of at least one of the pixel predictors to provide a plurality of selected pixels;
determining, based on the selected pixels, suspected defect bounding boxes; and
responding to the determining.

2. The method according to claim 1, wherein the selected aspect ratios are learnt during a supervised training process.

3. The method according to claim 2, wherein the selected aspect ratios are learnt during a supervised training process by clustering aspect ratios of tagged defects in a training dataset.

4. The method according to claim 3, wherein the selected aspect ratios belong to the largest clusters.

5. The method according to claim 1, wherein the selecting comprises selecting pixels that exhibit (a) a probability of defect above a probability threshold, and (b) a bounding box area above an area threshold; wherein the bounding box area equals a width of a bounding box multiplied by a length of the bounding box.

6. The method according to claim 1, wherein determining comprises setting centers of the suspected defect bounding boxes at centers of the selected pixels.

7. The method according to claim 1, wherein the determining comprises applying a non-maximum suppression process on bounding boxes associated with the selected pixels.

8. The method according to claim 1, wherein the one or more feature maps are multiple feature maps associated with different spatial resolutions.

9. A non-transitory computer readable medium for defect detection prediction with a compact set of prediction channels, the non-transitory computer readable medium stores instructions that cause a processor to:
receive a manufactured item (MI) image;
generate, by applying a machine learning process, pixel predictions per multiple pixels of one or more feature maps related to the MI image; wherein the pixel predictions consist essentially of a probability (P) of defect, bounding height (H) and bounding box width (W); wherein the machine learning process was trained to (i) detect defects bounded by bounding boxes that have selected aspect ratios, and (ii) ignore defects bounded by bounding boxes that have non-selected aspect ratios;
select, out of the multiple pixels, pixels based on values of at least one of the pixel predictors to provide a plurality of selected pixels;
determine, based on the selected pixels, suspected defect bounding boxes; and
participate in a response to the determining.

10. The non-transitory computer readable medium according to claim 9, wherein the selected aspect ratios are learnt during a supervised training process.

11. The non-transitory computer readable medium according to claim 10 wherein the selected aspect ratios are learnt during a supervised training process by clustering aspect ratios of tagged defects in a training dataset.

12. The non-transitory computer readable medium according to claim 11 wherein the selected aspect ratios belong to the largest clusters.

13. The non-transitory computer readable medium according to claim 9, wherein the selecting comprises selecting pixels that exhibit (a) a probability of defect above a probability threshold, and (b) a bounding box area above an area threshold; wherein the bounding box area equals a width of a bounding box multiplied by a length of the bounding box.

14. The non-transitory computer readable medium according to claim 9, wherein determining comprises setting centers of the suspected defect bounding boxes at centers of the selected pixels.

15. The non-transitory computer readable medium according to claim 9, wherein the determining comprises applying a non-maximum suppression process on bounding boxes associated with the selected pixels.

16. The non-transitory computer readable medium according to claim 9, wherein the one or more feature maps are multiple feature maps associated with different spatial resolutions.
